(19) United States
(12) Patent Application Publication
(10) Pub. No.: US 2012/0139801 A1
(43) Pub. Date: Jun. 7, 2012

(54) INTEGRATED ANTENNA

(76) Inventors: Hideaki Oshima, Tokyo (JP); Satoru Komatsu, Wako-shi (JP)

(21) Appl. No.: 13/389,636

(22) PCT Filed: Aug. 6, 2010
(86) PCT No.: PCT/JP2010/063400

§ 371 Date: Feb. 9, 2012

(30) Foreign Application Priority Data
Aug. 11, 2009 (JP) 2009 186402

(51) Int. Cl. H01Q 1/32

(52) U.S. Cl. 343/712

(57) ABSTRACT

An integrated antenna (20) is provided with branching lines (41, 42), consisting of liner-formed conductors elongating in the left-right direction, on: a ninth line (29) that elongates from a first line (22) at a place near an electricity supplying unit (23), towards a fourth line (21); and on an eleventh line (33) that elongates from the first line (22) at a place other side of the electricity supplying unit (23), towards the fourth line (21), and in parallel with the ninth line (29). A media reception band, different from the reception band made by a loop composed by combining the first to twelfth lines (23-38), is assigned to these branching lines (41, 42).

### TECHNICAL FIELD

The present invention relates to an integrated antenna having functions as both, e.g., a terrestrial digital television (DTV) antenna and a Global Positioning System (GPS) antenna, and in particular to such an integrated antenna installed on a window pane of a vehicle.

### BACKGROUND ART

Integrated DTV and GPS film antennas for vehicular window glasses are increasingly popular because these integrated film antennas can be installed on a small area and or have improved appearance. The integrated antenna includes plural antenna elements of different performances, and is simply designed so that the antenna elements can be installed in a small area. One exemplary integrated antenna is disclosed in Patent Literature 1 below.

The integrated antenna disclosed in Patent Literature 1 will be discussed with reference to FIG. 8 hereof.

As shown in FIG. 8(a), an integrated antenna system 100 includes a DTV antenna having a rectangular loop-shaped antenna element. Power feeding terminals 111, 112 are disposed on opposite ends of the antenna element. The power feeding terminal 111 is a hot side terminal, and the power feeding terminal 112 is an earth side terminal.

A GPS antenna 120, which includes a loop antenna 120a and a non-power-feeding element 120b, receives a radio wave of a frequency higher than a frequency used in digital TV broadcasting, such that the loop antenna 120a can be smaller in size than the rectangular loop-shaped antenna element of the DTV antenna 110. The GPS antenna 120 is therefore disposed inside a loop defined by the rectangular loop-shaped antenna element of the DTV antenna 110.

The GPS antenna 120 has two power-feeding terminals disposed proximate the power-feeding terminals 111, 112 of the DTV antenna 110. One of these two terminals of the GPS antenna is a hot side terminal 121 provided independently of in the two power-feeding terminals 111, 112 of the DTV antenna 110. The other one of the two terminals of the GPS antenna is an earth side terminal which also serves as the earth side terminal 112 of the DVT antenna 110. Therefore, the terminals 121, 112 of the GPS antenna 120 and the terminals 111, 112 of the DTV antenna 110 can be connected to a single connector 130 including three connection terminals 130a, 130b, 130c as shown in FIG. 8(b).

The connection terminals 130a, 130b, 130c of the connector 130 are connected to the terminals 111, 121, 112 shown in FIG. 8(a), respectively. Connected to the connector 130 are coaxial cables 131, 132. The coaxial cable 131 is adapted to transmit a GPS signal received by the GPS antenna 120, and the coaxial cable 132 is adapted to transmit a DTV broadcast signal received by the DTV antenna 110.

The integrated antenna taught in Patent Literature 1 has undesirably increased number of terminals because of the terminal 111 or 121 which is not shared between the DTV antenna 110 and the GPS antenna 120. This results in the increased number of connectors on an input part of the connected amplifier module. The increased number of the connectors of the module enlarges the entire size of the amplifier module.

Each antenna has an amplifier-input part connected to a portion of an antenna pattern of another antenna, which portion is different from a power-feeding portion of the antenna. For example, a DTV antenna pattern has its amplifier-input part and a part connected to an amplifier-input part of a GPS antenna.

The amplifier-input part of the GPS antenna connected to the portion of the DTV antenna pattern has so high a resistance that the DTV antenna would excessively consume energy in receiving DTV radio waves. Such excess energy consumption would deteriorate a DTV antenna performance of receiving the DTV radio waves. The same applies to the GPS antenna.

Furthermore, a simple loop shape of the DTV antenna pattern would not provide sufficient performance for overall DTV frequency band.

The connection of the GPS antenna to the terminal of the DTV antenna makes it difficult to change the configuration of the DTV antenna in such a manner as to obtain a predetermined characteristic for improving the performance of the DTV antenna while maintaining GPS performance. Accordingly, there has been demand for an integrated antenna system including antennas one of which has a performance improved in such a manner as to provide less effect on the performance of the other antenna.

### PRIOR ART LITERATURE

### Patent Document

Patent Literature 1: JP-A 2006-186488

### SUMMARY OF INVENTION

### Technical Problem

An object of the present invention is to provide an integrated antenna having the reduced number of components by sharing a plurality of antenna terminals between antenna elements one of which has a performance improved in such a manner as to provide less effect on a performance of the other antenna element.

### Solution to Problem

According to one aspect of the present invention, there is provide an integrated antenna on a window pane of a vehicle, the integrated antenna comprising: a first line having a power feeder disposed centrally thereof; second and third lines extending from opposite ends of the first line in the same direction perpendicular to the first line; a fourth line interconnecting distal ends of the second and the third lines, the fourth line being disposed in opposed relation to the first line; the first line, the second and third lines, and the fourth line defining one loop; a fifth line interconnecting the first line and the fourth line, the fifth line being disposed on a side of the second line within the loop; a sixth line interconnecting the fifth line and the second line; a seventh line interconnecting the first line and the fourth line, the seventh line being disposed on a side of the third line within the loop, the seventh line being disposed in parallel to the third line; an eighth line interconnecting the seventh line and the third line; a ninth line extending from the power feeder or a portion of the first line toward the fourth line, the portion of the first line being disposed proximate the power feeder; a tenth line interconnecting a distal end of the ninth line and the fifth line; an eleventh line extending from the first line towards the fourth line with the power feeder being interposed between the ninth line and the eleventh line, the eleventh line being disposed in parallel to the ninth line; a twelfth line interconnecting a distal end of the eleventh line and the seventh line; and branch lines made of a linear conductor extending leftward from the ninth line and rightward from the eleventh line, wherein the branch lines receive media assigned a frequency band different from a frequency band assigned to media received by a loop defined by a combination of ones of the first through twelfth lines.

Preferably, the loop has a high-impedance to the frequency band of the media received by the branch lines.

Preferably, the window pane includes a first area where a heat-reflecting film is formed, and a second area free from the heat-reflecting film, the first through twelfth lines and the branching lines being printed on the second area.

### Advantageous Effects of Invention

The integrated antenna according to the present invention has the ninth line extending from the power feeder or the point of the first line located proximate the power feeder, toward the fourth line. The integrated antenna also includes the eleventh line extending from the first line toward the fourth line in parallel to the fourth line with the power feeder interposed between the ninth line and the eleventh line. The antenna further includes the branch lines made from a linear conductor and extending leftward and rightward from the ninth line and the eleventh line, respectively. The branch lines receive media assigned a frequency band which is different from that assigned to a loop defined by a combination of ones of the first through twelfth lines. Therefore, the power feeder can be shared between the branch lines and the loop defined by the combination of ones of the first through twelfth lines. Accordingly, it becomes possible to feed power to the respective antennas without having to connect a dedicated electricity-supplying terminal to each of the antennas of the integrated antenna. This results in the reduced number of components of the integrated antenna.

Also, connected load, which leads to energy loss, is eliminated in each of the antennas, and a stable antenna performance can therefore be obtained in each of the antennas. Also, the lines of the loop that are connected to the power feeder include left and right lines that are parallel to each other. The branch lines are formed, e.g., by at least two linear conductors extending in a bilaterally symmetrical manner and are orthogonal to the left and right lines. The branch lines are formed by so-called dipole-type antennas.

For example, the integrated antenna includes the dipole GPS antenna having high impedance to the DTV band without providing greater effect on the characteristics in the DTV band. Also, the left line and the right line, which are parallel to each other, function as a transmission path for the GPS antenna.

The integrated antenna according to the present invention includes the loop having high impedance to the media received the branch lines. Therefore, even if, e.g., a dipole-type GPS antenna that corresponds to a high impedance in the DTV band is disposed on the branching lines, any effect on characteristics in the DTV band is minimized.

In the integrated antenna according to the present invention, the heat-reflecting film has been removed from a region of the window pane on which the branch lines are printed. Therefore, it is possible to obtain satisfactory antenna performance, comparable to an instance in which no heat-reflecting film is formed on the window pane.

### BRIEF DESCRIPTION OF DRAWINGS

FIG. 1 is a plan view of a vehicle having an integrated antenna in an embodiment of the present invention;

FIG. 2 is a view showing a basic structure of the integrated antenna in the embodiment of the present invention;

FIG. 3 is a view showing a first loop defined by elements of the integrated antenna of the present invention;

FIG. 4 is a view showing a second loop defined by elements of the integrated antenna of the present invention;

FIG. 5 is a view showing characteristics of a sensitivity of a DTV antenna element that constitutes the integrated antenna in the embodiment of the present invention;

FIG. 6 is a view evaluating a performance of a GPS antenna element that forms the integrated antenna in the embodiment of the present invention;

FIG. 7 is a view evaluating a performance of the GPS antenna element of the integrated antenna in the embodiment of the present invention when the integrated antenna has heat-reflecting film and when the integrated antenna is free from the film; and

FIG. 8 is a view showing an example of a conventional integrated antenna.

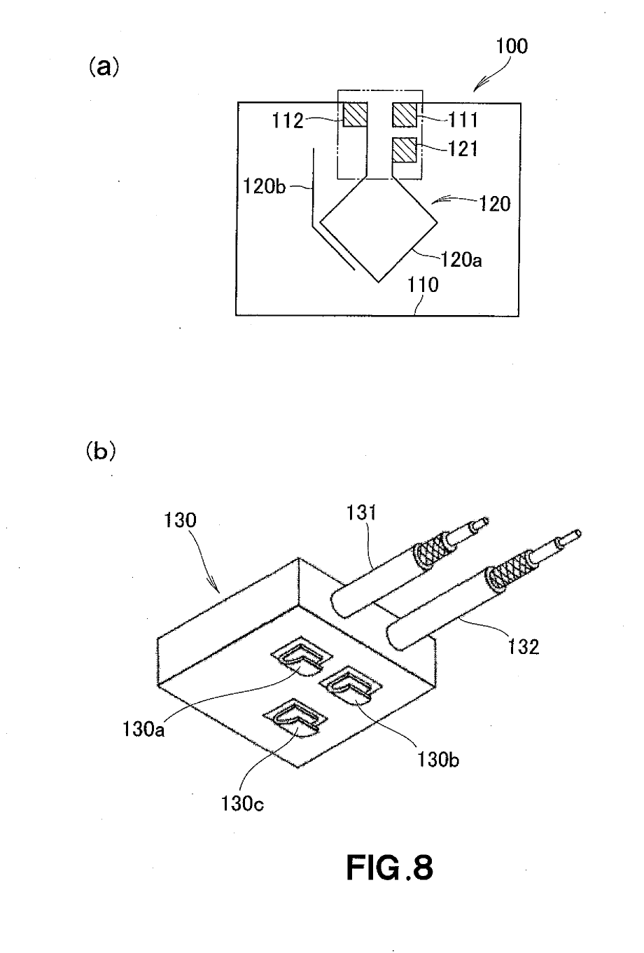

### DESCRIPTION OF EMBODIMENTS

An embodiment of the present invention will now be described with reference to the attached drawings.

### Embodiment

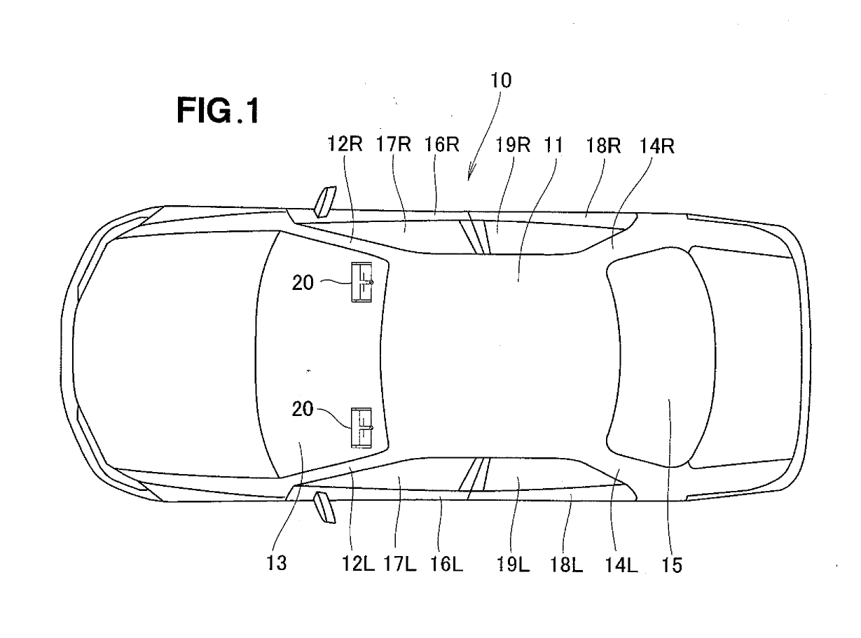

The integrated antenna according to the present invention can be mounted on a window pane of a vehicle. More specifically, as shown in FIG. 1, a vehicle 10 is provided with window panes comprising a windshield 13 fitted between left and right front pillars 12L, 12R of a vehicle body 11, a rear window pane 15 fitted between rear pillars 14L, 14R, front door window panes 17L, 17R mounted on front doors 16L, 16R to move up and down, and rear door window panes 19L, 19R mounted on rear doors 18L, 18R to move up and down.

The integrated antenna can be mounted on any of the windshield 13 and window panes 15, 17L, 17R, 19L, 19R. In the embodiment, the integrated antenna 20 is provided to both of a top right corner and a top left corner of the windshield 13. Although FIG. 1 shows an example of a laterally disposed antenna pattern, such an antenna pattern may be oriented longitudinally by rotating through 90°. The integrated antenna 20 is used as a GPS antenna in addition to as a DTV antenna designed to receive a terrestrial digital broadcast that uses a terrestrial Ultra High Frequency (UHF) band primarily for an automotive TV set.

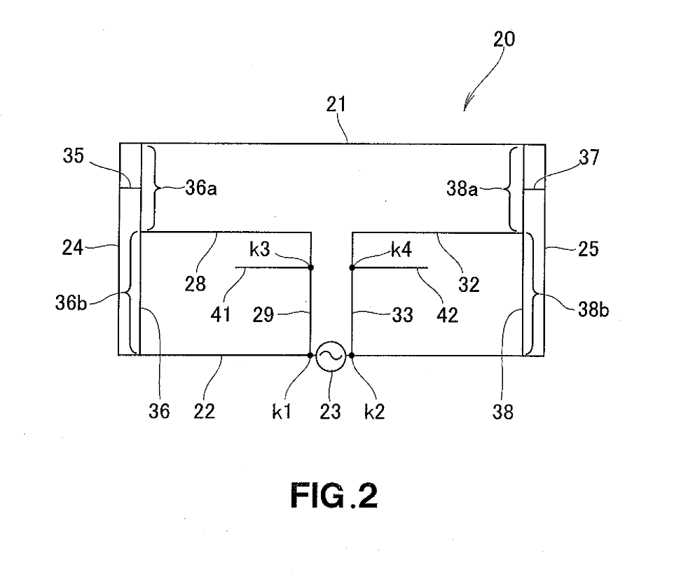

As shown in FIG. 2, the integrated antenna 20 is made from linear conductors. The integrated antenna 20 comprises an upper line (a fourth line 21) extending leftward and rightward, a lower line (a first line 22) disposed below and in parallel to the fourth line 21, and the power feeder 23 provided at a centre of the first line 22 for driving the integrated antenna 20.

Respective left ends of the fourth line 21 and the first line 22 are connected together through a left line (a second line 24), and respective right ends of the fourth line 21 and the first line 22 are connected together through a right line (a third line 25). The second line 24 and the third line 25 are parallel to each other and perpendicular to the first line 22 and the fourth line 21. The first and fourth lines 22, 21 and the second and third lines 24, 25 define one rectangular loop.

In addition, a left first line 36a, which has a length approximately half that of the second line 24, extends downward from a point of the fourth line 21 slightly offset inward from the left end of the fourth line 21. A left second line (a tenth line 28), which has a length less than half that of the fourth line 21, extends rightwards from a lower end of the left first line 36a. A left third line (a ninth line 29; a left line that connects a second loop to the power feeder 23) extends downwards from a distal end of the tenth line 28. The ninth line 29 is connected to the first line 22 at a junction k1.

Similarly, a right first line 38a, which has a length approximately half that of the third line 25, extends downward from a position of the fourth line 21 slightly offset inward from the right end of the fourth line 21. A right second line (a twelfth line 32), which has a length less than half that of the fourth line 21, extends leftward from a lower end of the right first line 38a. A right third line (an eleventh line 33; a right line that connects the second loop to the power feeder 23) extends downward from a distal end of the twelfth line 32. The eleventh line 33 is connected to the first line 22 a junction k2.

The junction k1 is disposed leftward of the power feeder 23 and the junction k2 is disposed rightward of the power feeder 23.

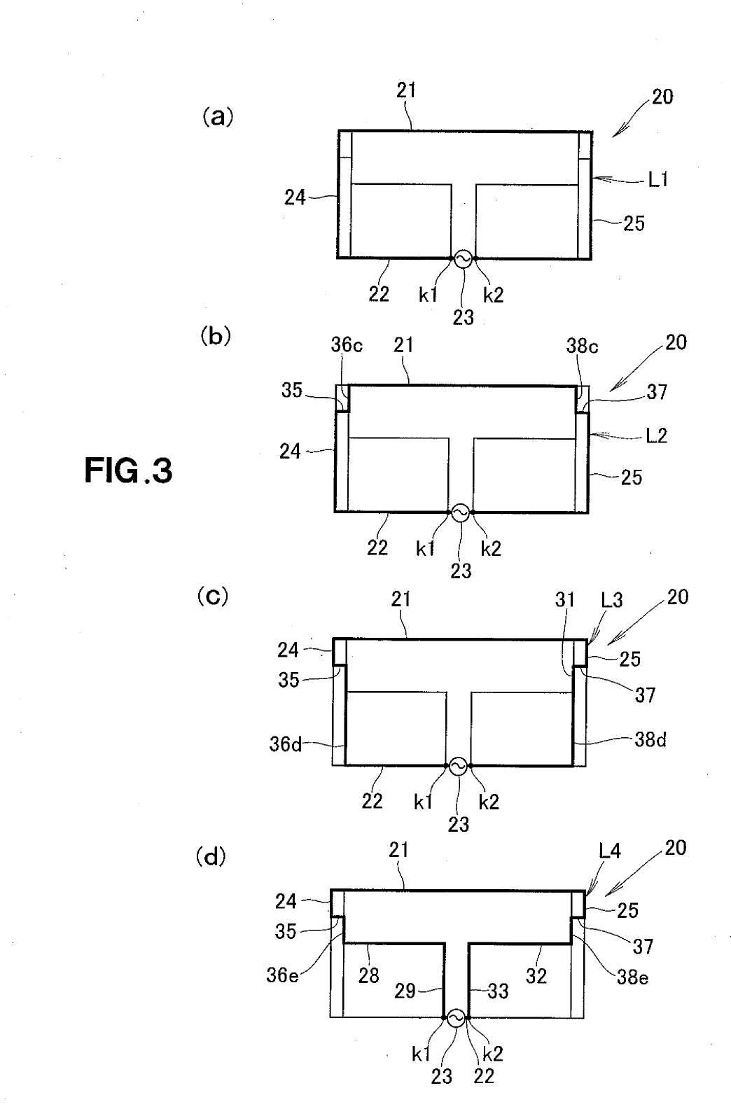

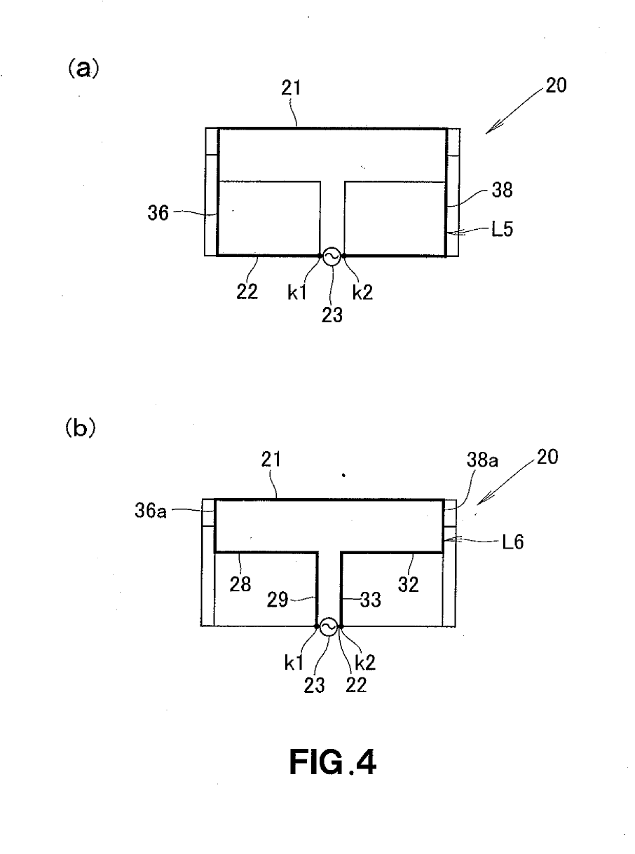

A left first connecting line 35 (a sixth line) interconnects the second line 24 and the left first line 36a. The left first connecting line 35 extends the shortest interval between the second line 24 and the left first line 36a. A left second connecting line 36b extends from the lower end of the left first line 36a to the first line 22. The left first line 36a and the left second connecting line 36b define a fifth line 36. The fifth line 36 may include lines 36c, 36d, and 36e depending on a loop discussed below with reference to FIG. 3 and FIG. 4.

Similarly, a right first connecting line 37 (an eighth line) interconnects the third line 25 and the right first line 38a. The right first connecting line 37 extends the shortest interval between the third line 25 and the right first line 38a. A right second connecting line 38b extends from the lower end of the right first line 38a to the first line 22. The right first line 38a and the right second connecting line 38b define a seventh line 38. The seventh line 38 may also include lines 38c, 38d, and 38e depending on a loop discussed below with reference to FIG. 3 and FIG. 4.

The integrated antenna 20 provides first and second loops. The first loop will now be described with reference to FIG. 3.

A loop L1 is indicated by a bold line shown in FIG. 3(a).

The loop L1 extends from the power feeder 23 along the first line 22, the second line 24, the fourth line 21 and the third line 25, and again the first line 22, and returns to the power feeder 23. The loop L1 is greater in length than loops L5, L6 described below.

A loop L2 is indicated by a bold line shown in FIG. 3(b). The loop L2 extends from the power feeder 23 along the first line 22, the second line 24, the sixth line 35, the fifth line (line 36c), the fourth line 21, the seventh line (line 38c), the eighth line 37, the third line 25 and again the first line 22, and returns to the power feeder 23.

The loop L2 has the same length as that of the loop L1 described above, but has an upper part disposed inward of the loop L1 because the upper part of the loop L2 takes routes defined by the sixth line 35 and the eighth line 37.

A loop L3 indicated by a bold line shown in FIG. 3(c). The loop L3 extends from the power feeder 23 along the first line 22, the fifth line (line 36d), the sixth line 35, the second line 24, the fourth line 21, the third line 25, the eighth line 37, the seventh line (38d) and again the first line 22, and returns to the power feeder 23.

The loop L3 has the same length as that of each of the above-mentioned loops L1, L2. However, the loop L3 has a lower part disposed inside the second and third lines 24, 25 because the lower part of the loop L3 takes routes defined by the sixth, fifth, eighth, and seventh lines 35, 36d, 37, 38d.

A loop L4 indicated by a bold line shown in FIG. 3(d). The loop L4 extends from the power feeder 23 along the first line 22, the ninth line 29, the tenth line 28, the fifth line 36e, the sixth line 35, the second line 24, the fourth line 21, the third line 25, the eighth line 37, the seventh line 38e, the twelfth line 32, the eleventh line 33, and again the first line 22, and returns to the power feeder 23. The loop L4 has the same length as that of each of the above-mentioned loops L1 through L3, but has a lower part disposed inward of the loop L3.

In other words, the above-mentioned loops L1 through L4 form lines having the same length but takes different routes.

Next, a second loop will be described with reference to FIG. 4.

A loop L5 indicated by a bold line shown in FIG. 4(a). The loop L5 extends from the power feeder 23 along the first line 22, the fifth line 36, the fourth line 21, the seventh line 38 and again the first line 22, and returns to the power feeder 23. The loop L5 has left and right portions disposed inward of the loop L1, and has a length that is correspondingly shorter.

A loop L6 indicated by a bold line shown in FIG. 4(b). The loop L6 extends from the power feeder 23 along the first line 22, the ninth line 29, the tenth line 28, the fifth line 36a, the fourth line 21, the seventh line 38a, the twelfth line 32, the eleventh line 33 and again the first line 22, and returns to the power feeder 23. In other words, the loop L6 has the same length as that of the loop L5 described above, but has a lower part disposed inward of the loop L5.

The loops L1 through L6 shown in FIGS. 3(a) through 3(d) and FIGS. 4(a), 4(b) described above are grouped into: loops of relatively large length; and loops of relatively small length.

The loops L1 to L4 (corresponding to a first loop) of relatively large length are used for receiving radio waves of relatively low frequency. Of the loops L1 to L4, one having an optimum input impedance is used in receiving a radio wave of low frequency. The provision of the plural loops L1 to L4 makes it possible to receive radio waves over a broad low frequency band.

The loops L5, L6 (corresponding to a second loop) of relatively small length are used for receiving radio waves of relatively high frequency. Of the loops L5, L6, one having an optimum input impedance is used in receiving a radio wave of high frequency. The provision of the loops L5, L6 makes it possible to receive radio waves over a broad high frequency band.

Turning back to FIG. 2, the ninth line 29 and the eleventh line 33 of the loop L6 have relay points k3, k4. Two branch lines 41, 42 (resonance elements used for GPS) extending a predetermined length from the relay points k3, k4, respectively in a bilaterally symmetrical manner. The branch lines 41, 42 are orthogonal to the ninth line 29 and the eleventh line 33. The branching lines 41, 42 may also extend left and right without being symmetrical or without being at a right angle. The branch lines 41, 42 are hereafter referred to as antenna elements 41, 42.

The provision of the antenna elements 41, 42 connected to the ninth and eleventh lines 29, 33 makes it possible to share the power feeder 23 without connecting a dedicated feeding terminal to each of the DTV antenna and the GPS antenna element (branching lines 41, 42). This results in the reduced number of components of the integrated antenna 20. Also, connected load, which leads to energy loss, is eliminated in relation to each of the antennas, and a stable antenna performance can therefore be obtained in each of the antennas.

The GPS antenna elements 41, 42 are so-called dipole-type GPS antennas, and assigned a frequency band corresponding to a high impedance in the DTV band. Therefore, even when the GPS antenna elements 41, 42 are disposed in the manner as stated above, there is minimal effect on characteristics of the DTV band. Also, the ninth and the eleventh lines 29, 33 function as a type of transmission path for the GPS antenna elements 41, 42, and the lines themselves therefore do not adversely affect the GPS performance.

The integrated antenna 20 according to the present invention comprises one loop configured from a first line 22 having a power feeder 23 at a center; a second line 24 and a third line 25 extending from both ends of the first line 22 perpendicularly in an identical direction; and a fourth line 21 joining respective distal ends of the second line 24 and the third line 25, the fourth line 21 being arranged opposite the first line 22; a fifth line 36 linking the first line 22 and the fourth line 21 at a position further inward from the second line 24; a sixth line 35 linking the fifth line 36 and the second line 24; a seventh line 38 linking the first line 22 and the fourth line 21 at a position further inward from the third line 25, the seventh line 38 being arranged parallel to the third line 25; an eighth line 37 linking the seventh line 38 and the third line 25; a ninth line 29 extending from the power feeder 23 or the first line 22 in a vicinity of the power feeder 23 towards the fourth line 21; a tenth line 28 joining a distal end of the ninth line 29 and the fifth line 36; an eleventh line 33 extending from the first line 22 towards the fourth line 21 so as to be parallel to the ninth line 29 with the power feeder interposed therebetween; a twelfth line 32 joining a distal end of the eleventh line 33 and the seventh line 38; and branch lines 41, 42, made from a linear conductor extending left and right from the ninth line 29 and the eleventh line 33 respectively; wherein a reception band for a media that is different to that assigned to a loop configured from a combination of the first through twelfth lines 22 through 38 is assigned to the branch lines 41, 42.

Next, the inventors of the present invention have prepared the integrated antenna 20 according to the embodiment of the present invention shown in FIG. 2 and an ordinary antenna that does not include the GPS antenna elements 41, 42, and studied the characteristics of the sensitivities, of the respective DTV antennas.

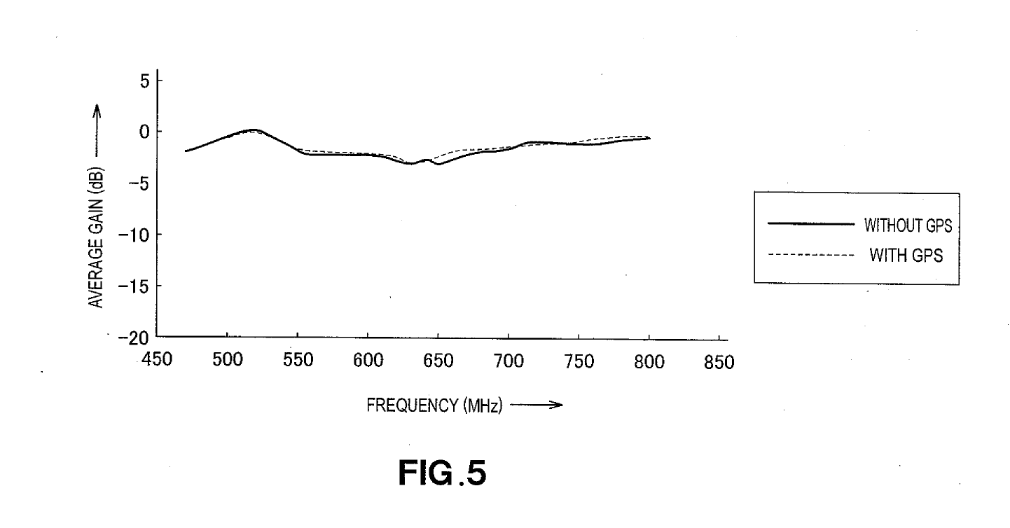

The results are shown in FIG. 5.

FIG. 5 is a graph showing sensitivity of the integrated antenna 20. The graph has a horizontal axis showing a frequency (MHz) and a vertical axis showing average gain (dB). A solid line shows the sensitivity of the integrated antenna 20 when the antenna 20 includes the GPS antenna elements, and a broken line shows the sensitivity of the integrated antenna 20 when the antenna 20 does not include the GPS antenna elements. The average gain (dB), represented by the vertical axis, is normalized so that a maximum average gain when the GPS antenna elements are not included is 0 dB.

As can be seen from FIG. 5, substantially identical sensitivity characteristics can be obtained whether or not the antenna 20 includes the GPS antenna elements. It was therefore found that adding the GPS antenna elements 41, 42 does not affect the DTV band.

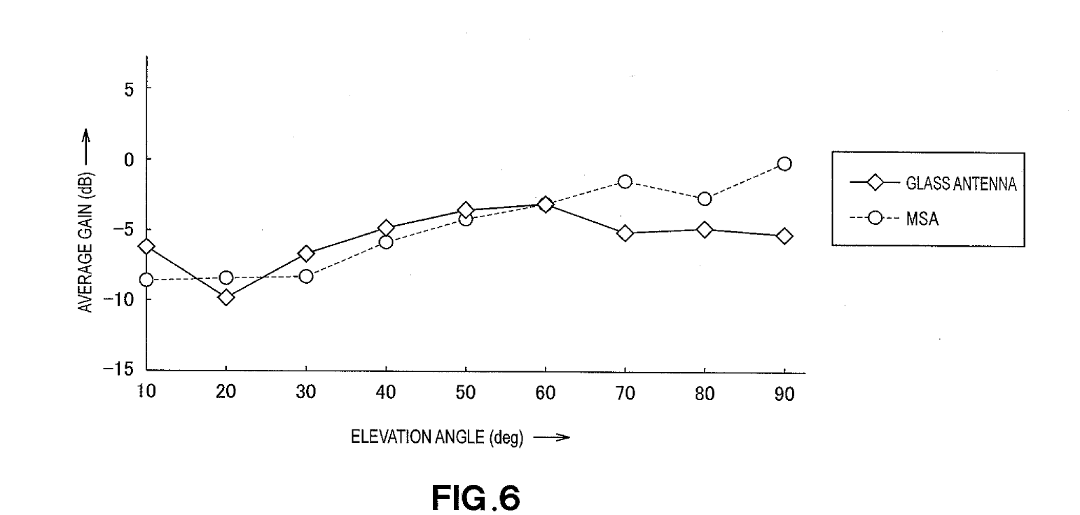

Next, the inventors of the present invention have performed an evaluation of the performance of the GPS antenna of the integrated antenna 20 disposed on different points of the vehicle 10 shown in FIG. 1. The results of the evaluation are shown in FIG. 6.

FIG. 6 is a graph showing evaluation of the GPS function. The graph has a vertical axis showing the average gain (dB) and a horizontal axis showing the elevation angle (deg). A line marked “⋄” shows reception characteristics for the integrated antenna 20 printed on a windshield or rear window pane, and a line marked “◯” shows reception characteristics for a microstrip antenna (MSA) set on a dashboard. The MSA is normally often used as a GPS antenna. The average gain (dB) represented by the vertical axis is normalized so that an average gain when the MSA elevation angle is 90° is 0 dB.

As can be seen from FIG. 6, the integrated antenna 20 according to the embodiment of the present invention can achieve a performance similar to that of the MSA for GPS set on a roof or a dashboard, and, in particular, can achieve a performance equal to or superior to that of the MSA for GPS at low and medium elevation angles. Therefore, it has been found that the integrated antenna 20 can be sufficiently practically used as a GPS antenna.

The left and right third lines 29, 33 on an inner one (the loop L6) of the loops L1 to L6 for receiving radio waves over a high frequency band is connected to the power feeder as well as to the antenna elements (the GPS antenna) for receiving radio waves over a frequency band different from that of the radio waves received by the inner loop. This is advantageous in that the power feeder 23 is shared between the DTV antenna and the GPS antenna to thereby supply power to the DTV and GPS antennas without having to connect a dedicated electricity-supplying terminal to each of the above-mentioned antennas of the integrated antenna 20. This results in the reduced number of components of the integrated antenna 20.

Also, connected load, which leads to energy loss, is eliminated in relation to each of the antennas, and a stable antenna performance can therefore be obtained in each of the antennas.

The integrated antenna 20 has the dipole-type GPS antenna elements having high impedance to the DTV band without providing greater effect on the characteristics of the DTV antenna. Also, the left and right third lines 29, 33 function as a transmission path for the GPS antenna, and hence the lines 29, 33 themselves do not adversely affect the GPS performance.

The conductive line length of the branching lines 41, 42 can be adjusted to integrate the antennas with, e.g., an antenna for an electronic toll collection (ETC) system, satellite radio, or another medium other than a GPS antenna. In such an instance, antenna design is facilitated.

A heat-reflecting glass having a low infrared transmittance is occasionally used for a window pane 13 onto which the integrated antenna 20 is printed, in order to decrease air-conditioning load or to reduce the perception of heat from direct sunlight. Heat-reflecting glass, which meets such demands, has its surface coated with a heat-reflecting film. Some composition of heat-reflecting film may have a high electrical conductivity and potentially adversely affect antenna performance. With these components of the film taken into consideration, the heat-reflecting film is removed from a region of the window pane 13 onto which the integrated antenna 20 is printed, as well as from the surroundings of that region.

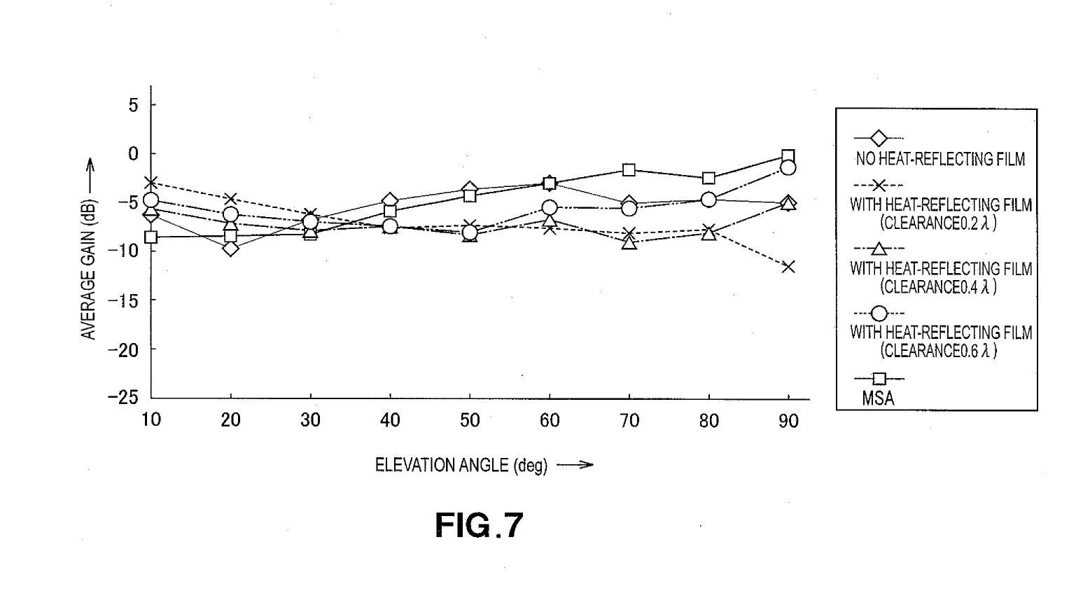

The present inventors have installed the integrated antenna 20 onto the window pane 13 (heat-reflecting glass) of the vehicle 10 shown in FIG. 1, and performed an evaluation of the performance of the GPS antenna. The results are shown in FIG. 7.

FIG. 7 is a GPS function evaluation graph, where the vertical axis represents the average gain (dB) and the horizontal axis represents the elevation angle (deg). The diagram shows, as a comparison, the respective reception performance for an instance in which a heat-reflecting film is formed on the window pane 13; instances in which a heat-reflecting film is formed and in which the clearance is 0.2λ, 0.4λ, and 0.6λ respectively; and an instance in which a microstrip antenna (MSA), which is normally often used as a GPS antenna, is set up on a dashboard (respectively represented by ⋄, x, Δ, ∘, and □). The term “clearance” used herein refers to an interval between the heat-reflecting film and the integrated antenna 10. In the GPS performance evaluation diagram, the average gain (dB) represented by the vertical axis is normalized so that an average gain when the elevation angle of the MSA is 90° is 0 dB.

As can be seen in plots represented by x, Δ, and ∘ in FIG. 7, it was found that even if a heat-reflecting film is formed on a surface of the window pane 13, removing a portion of the heat-ray-reflecting film on a region on which the antenna is installed and on a surrounding region makes it possible to obtain a satisfactory antenna performance. The region from which the heat-ray-reflecting film is to be removed preferably corresponds to a clearance of 0.4λ or greater as shown by plots represented by Δ, and ∘ (and a clearance of 0.2λ as represented by x is also possible). The fall in performance can be kept to 5 dB or less even when compared to an instance in which no heat-ray-reflecting film is formed as shown by plots represented by ⋄, and the fall in performance can be kept to 10 dB or less even when compared to an MSA provided on the dashboard as represented by □. λ represents an effective wavelength on a surface of the window pane 13 (i.e., a value obtained by multiplying a GPS reception frequency of 1.575 GHz by a fractional shortening value).

### INDUSTRIAL APPLICABILITY

The present invention is favorably used as an integrated antenna installed on a window pane of a vehicle, in which antennas for a plurality of media are integrated into one antenna pattern.

### REFERENCE SIGNS LIST

10 Vehicle
13 Window pane (windshield)
20 Integrated antenna
21 Fourth line
22 First line
23 Electricity-supplying unit
24 Second line
25 Third line
28 Tenth line
29 Ninth line
32 Twelfth line
33 Eleventh line
35 Sixth line
36 Fifth line
37 Eighth line
38 Seventh line
41, 42 Branching lines
L1 through L4 First loop
L5 through L6 Second loop

1. An integrated antenna on a window pane of a vehicle, the integrated antenna comprising:
a first line having a power feeder disposed centrally thereof;
second and third lines extending from opposite ends of the first line in the same direction perpendicular to the first line;
a fourth line interconnecting distal ends of the second and the third lines, the fourth line being disposed in opposed relation to the first line;
the first line, the second and third lines, and the fourth line defining one loop;
a fifth line interconnecting the first line and the fourth line, the fifth line being disposed on a side of the second line within the loop;
a sixth line interconnecting the fifth line and the second line;
a seventh line interconnecting the first line and the fourth line, the seventh line being disposed on a side of the third line within the loop, the seventh line being disposed in parallel to the third line;
an eighth line interconnecting the seventh line and the third line;
a ninth line extending from the power feeder or a portion of the first line toward the fourth line, the portion of the first line being disposed proximate the power feeder;
a tenth line interconnecting a distal end of the ninth line and the fifth line;
an eleventh line extending from the first line towards the fourth line with the power feeder being interposed between the ninth line and the eleventh line, the eleventh line being disposed in parallel to the ninth line;
a twelfth line interconnecting a distal end of the eleventh line and the seventh line; and
branch lines made of a linear conductor extending leftward from the ninth line and rightward from the eleventh line,
wherein the branch lines receive media assigned a frequency band different from a frequency band assigned to media received by a loop defined by a combination of ones of the first through twelfth lines.

2. The integrated antenna according to claim 1, wherein the loop has a high impedance to the frequency band of the media received by the branch lines.

3. (canceled)

4. The integrated antenna according to claim 2, wherein the window pane includes a first area where a heat-reflecting film is formed, and a second area free from the heat-reflecting film, the first through twelfth lines and the branching lines being printed on the second area.

5. The integrated antenna according to claim 1, wherein the window pane includes a first area where a heat-reflecting film is formed, and a second area free from the heat-reflecting film, the first through twelfth lines and the branching lines being printed on the second area.
